(19) United States
(12) Patent Application Publication
(10) Pub. No.: US 2024/0397863 A1
(43) Pub. Date: Dec. 5, 2024

(54) AUTONOMOUS AGRICULTURAL ROBOT COMPRISING A CROP PROTECTION DEVICE

(71) Applicant: NAÏO-TECHNOLOGIES, ESCALQUENS (FR)

(72) Inventors: Joan ANDREU, AIROUX (FR); Franck JUNG, MONTLAUR (FR); Denis MOINDRAULT, MAUREMONT (FR); Bruno MATHIEU, CASTANET (FR); Cédric SEGUINEAU, AUTERIVE (FR); Gaëtan SÉVERAC, TOULOUSE (FR)

(21) Appl. No.: 18/698,261

(22) PCT Filed: Oct. 4, 2022
(86) PCT No.: PCT/EP2022/077499

§ 371 Date: Apr. 3, 2024

(30) Foreign Application Priority Data
Oct. 5, 2021 (FR) FR2110534

(51) Int. Cl. A01D 41/127; A01B 69/04

(52) U.S. Cl. CPC A01D 41/127; A01B 69/008

(57) ABSTRACT

An autonomous agricultural robot including: a control unit and treatment tools. The autonomous agricultural robot being characterised in that it includes a protective device. This protective device is configured to: measure characteristic quantities of so-called upstream crops, these crops being located upstream of the treatment tools; measure characteristic quantities of so-called downstream crops, these crops being located downstream of the treatment tools. The control unit being configured to: receive the measurements of the characteristic quantities of the upstream and downstream crops; perform a comparison of the measurements of the characteristic quantities of the same upstream and downstream crops; transmit a command for protecting the crop parcel to the autonomous agricultural robot when the comparison exceeds a predetermined threshold.

### CROSS REFERENCE TO RELATED APPLICATIONS

This application is a National Stage of International Application No. PCT/EP2022/077499, having an International Filing Date of 4 Oct. 2022, which designated the United States of America, and which International Application was published under PCT Article 21(2) as WO Publication No. 2023/057408 A1, which claims priority from and the benefit of French Patent Application No. 2110534 filed on 5 Oct. 2021, the disclosures of which are incorporated herein by reference in their entireties.

### BACKGROUND

### Field

The present disclosure relates to the field of agriculture and in particular of agricultural robots.

More specifically, the disclosure relates to an agricultural robot comprising a device for protecting a crop parcel to protect crop parcels from possible damage caused by the agricultural robot itself or its tools.

In particular, the disclosure finds applications in agricultural robots provided with automated or autonomous functions, which are dedicated to low, medium or high row crops, such as salads, wheat or vineyards.

### Brief Description of Related Developments

Agricultural robots moving and treating crops in an autonomous manner are known from the prior art. These agricultural robots comprise treatment tools. Said treatment tools may comprise an autonomous positioning system, enabling them, in an optimum operating configuration, to be properly positioned with respect to the crops to perform the treatment.

The treatment operations could require an accurate positioning of the treatment tools in the range of one centimetre. For example, weeding knives may be used in crop parcels, such as salads, and a poor positioning of said weeding knives, a misuse, the intrusion of an external element into the system (gravels, branch, etc.) or an inadvertent maladjustment of the tools (due to vibrations for example) might damage the treated crop.

A poor positioning or a misuse of the treatment tools might be due to a malfunction of the autonomous positioning system, or a malfunction of the treatment tools, the intrusion of an external element into the system (gravels, branch, etc.) or an inadvertent maladjustment of the tools (due to vibrations, for example). Thus, a malfunction of a control unit or of a location system could result in inaccuracies in the treatment of crops and damage them.

In order to verify that the treatment tools do not damage the crop parcel, a human supervision is, at the time being, necessary. This solution is not satisfactory, to the extent that the agricultural robot does not operate in full autonomy in the crop parcels.

Nevertheless, at the time being, without human supervision, the entire culture might be damaged following an aforementioned malfunction.

None of the current systems allows simultaneously addressing all of the required needs, namely proposing a technique for autonomous protection of a crop parcel in real-time, reliable and simple to implement.

### SUMMARY

The present disclosure aims to overcome all or some of the above-mentioned drawbacks of the prior art.

To this end, the disclosure relates to an autonomous agricultural robot comprising:
a control unit;
treatment tools allowing treating crops;
forward movement means enabling the autonomous agricultural robot to advance in a so-called advance direction within a crop parcel.

Said autonomous agricultural robot comprises a device for protecting the crop parcel, this protective device being configured to:
measure characteristic quantities of the so-called upstream crops, these crops being located upstream of the treatment tools before passage of the treatment tools over the crops with respect to the advance direction;
measure characteristic quantities of said downstream crops, said crops being located downstream of the treatment tools after the treatment tools pass over the crops with respect to the advance direction;

The control unit is configured to:
receive the measurements of the characteristic quantities of the upstream and downstream crops originating from the protective device;
process the measurements of the characteristic quantities of the crops read by the protective device and performing a comparison of the measurements of the characteristic quantities of the same upstream and downstream crop, corresponding to the comparison of the characteristic quantities of said culture before and after passage of the treatment tools;
transmit a command for protecting the crop parcel to the autonomous agricultural robot when the comparison exceeds a predefined threshold.

Advantageously, the disclosure allows having a real-time comparison of a characteristic quantity of a culture before treatment thereof by the treatment tools and after treatment thereof by the treatment tools. Advantageously, it allows protecting the other cultures of the parcel when a culture has been damaged, or when the protective device is defective.

In a particular aspect, the characteristic quantities measured by the protective device are an image of the crop and/or the width of the crop and/or the height of the crop and/or the angle formed by the crop with the soil and/or the position of the crop, and/or a spacing between the crop and another crop of the parcel.

Advantageously, these characteristic quantities allow characterising a crop. If the crop is damaged (for example, cut, displaced or twisted) by the treatment tools, the characteristic quantity of said crop before passage thereof through the treatment tools is different from the characteristic quantity of said culture after treatment thereof by the treatment tools. A comparison between the characteristic quantities of the same crop upstream and downstream of the treatment tools at two different time points allows ensuring that the crop has not been damaged by the treatment tools, or that the protective device is not defective.

In a particular aspect, the treatment tools are movable between two positions, a work position and a raised position. The control unit is configured to transmit the crop parcel protection command to the treatment tools which are positioned in the raised position.

Advantageously, this allows protecting the other crops of the parcel when a crop has been damaged, or the protective device is defective, and guiding the autonomous agricultural robot to a location where maintenance operations could be carried out easily.

In a particular aspect, the control unit is configured to transmit the crop parcel protection command to the forward movement means to stop the autonomous agricultural robot.

Advantageously, this aspect allows protecting the other crops of the parcel when a crop has been damaged, or the protective device is defective.

In a particular aspect, the autonomous agricultural robot comprises a location system, and the control unit is configured to associate the measurements of the characteristic quantities, read by the protective device, of the upstream and downstream crops at a position, estimated by the positioning system, of the characterised crop.

This aspect has the advantage of making the association of the measurements of the characteristic quantities of the same upstream and front culture, at two given time points, reliable.

In an advantageous aspect, the device for protecting the crop parcel comprises two characterisation devices, the first characterisation device being configured to measure the characteristic quantities of the upstream crops; the second characterisation device being configured to measure the characteristic quantities of the downstream crops.

In a particular aspect, the two crop characterisation devices are composed of sensors of the same type.

Advantageously, this allows simplifying the comparison between the two characteristic quantities and improving the reliability of the device for protecting the crop parcel.

In a particular aspect, a device for characterising the crops comprises image sensors.

This aspect confers on said characterisation device the advantage of limiting its bulk and its mass. In a particular aspect, the autonomous agricultural robot comprises a straddle frame defining a passage corridor for a crop row. The device for characterising the crops comprises movable arms arranged respectively on either side of a longitudinal midplane of the passage corridor, and one sensor per arm configured to measure a change in the position of said arm.

Advantageously, this aspect enables said characterisation device to be reliable, robust and simple to use.

In a particular aspect, the first crop characterisation device is positioned upstream of the treatment tools and the second crop characterisation device is positioned downstream of the treatment tools.

Advantageously, this allows simplifying integrations thereof on the autonomous agricultural robot.

The disclosure also relates to a method for protecting a crop parcel. Said method is implemented by an autonomous agricultural robot in a previously-described aspect, and it includes the steps of:
measuring the characteristic quantities of the upstream and downstream crops by the protective device;
transmitting said measurements to the control unit;
associating, by the control unit, measurements of the same upstream and downstream culture originating from the protective device;
comparing, by the control unit, the associated measurements;
transmitting a command for protecting the crop parcel by the control unit to the autonomous agricultural robot if the comparison exceeds a predefined threshold.

In a particular implementation, the method for protecting a crop parcel is implemented by an autonomous agricultural robot comprising a location system. Said method includes an additional preliminary step of reading the location of the crops.

The step of associating the measurements by the control unit comprises a first association of each measurement of characteristic quantities of a crop originating from the protective device with a positioning estimated by the location system of the characterised crop and a second association of the measurements of characteristic quantities originating from the protective device associated with the same positioning, said measurements corresponding to the measurements of the characteristic quantities of the same upstream and downstream crop.

This allows making the association of the measurements of the characteristic quantities, originating from the protective device, of the same crop at two given time points, before and after treatment by the treatment tools, reliable.

In a particular implementation, the step of transmitting a command for protecting the crop parcel by the control unit to the autonomous agricultural robot if the comparison exceeds a predefined threshold comprises sending a stop command by the control unit to the forward movement means of the autonomous agricultural robot.

Advantageously, this implementation allows stopping the autonomous agricultural robot and protecting the rest of the crop parcel when a culture has been damaged by the defective treatment means.

In a particular implementation, the step of transmitting a command for protecting the crop parcel by the control unit to the robot autonomous agricultural if the comparison exceeds a predefined threshold comprises sending a command for protecting the crop parcel by the control unit to the treatment tools which are in a so-called raised position, corresponding to a position in which said treatment tools have no contact with the crops.

Advantageously, this allows protecting the other crops of the parcel when a culture has been damaged by the treatment means, or when the protective device is defective, and guiding the autonomous agricultural robot towards a location where maintenance operations could be carried out easily.

In a particular implementation, the step of transmitting a command for protecting the crop parcel by the control unit to the autonomous agricultural robot if the comparison exceeds a predefined threshold comprises analysing the comparison and transmitting to the treatment tools a command for positioning the treatment tools.

Advantageously, this allows correcting the maladjustments of the treatment tools and continuing the treatment of the crops without damaging them.

The disclosure also relates to a method for mapping a crop parcel. Said mapping method is implemented by an autonomous agricultural robot in a previously-described aspect, comprising a location system. Said mapping method comprises the steps of:
measuring the characteristic quantities of the upstream crops by the protective device, transmitting to the control unit and detecting the upstream crops by the control unit;
associating, by the control unit, each of the detected upstream crops with their locations read by the location system;
integrating the location of each of the upstream crops with a first map by the control unit; said steps are implemented in parallel with the following three steps:

measuring the characteristic quantities of the downstream crops by the protective device, transmitting to the control unit and detecting the downstream crops by the control unit;
associating, by the control unit, each of the detected downstream crops with their locations read by the location system;
integrating the location of each of the downstream crops with a second map by the control unit;
For each location of the upstream crops originating from the first map, searching for the location of the closest downstream crop originating from the second map and associating the two locations by the control unit;
For each upstream crop derived from the first map, integrating the average of the two locations originating from the first and second maps into a third map by the control unit.

Advantageously, this method allows performing a very reliable and more accurate mapping than a conventional system with one single passage of the autonomous agricultural robot in the crop parcel.

### BRIEF DESCRIPTION OF THE FIGURES

Other particular advantages, aims and features of the present disclosure will become apparent from the following non-limiting description of at least one particular aspect of the devices and methods objects of the present disclosure, with reference to the appended drawings, wherein:

FIG. 1: a schematic side view of an autonomous agricultural robot equipped with a protective device at a time point t1;

FIG. 2: a schematic side view of an autonomous agricultural robot equipped with a protective device in the same aspect illustrated in FIG. 1 at a time point t2;

FIG. 3: a schematic side view of an autonomous agricultural robot equipped with a protective device in another aspect;

FIG. 4: a schematic front view of an agricultural robot in another aspect;

FIG. 5: a flowchart illustrating the method for protecting a crop parcel;

FIG. 6: a flowchart illustrating the method for mapping a crop parcel.

### DETAILED DESCRIPTION

The present description is given as a non-limiting example, each feature of one aspect could be advantageously combined with any other feature of any other aspect.

As of now, it should be noted that the figures are not plotted to scale.

### Example of a Particular Aspect

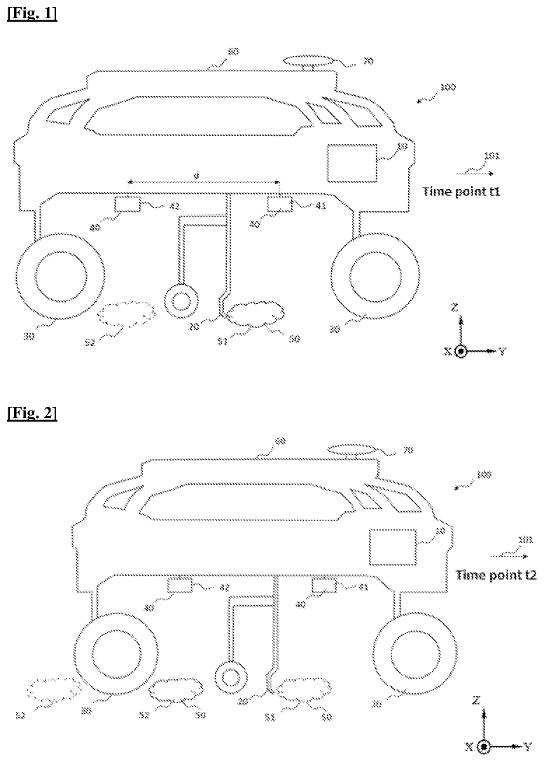

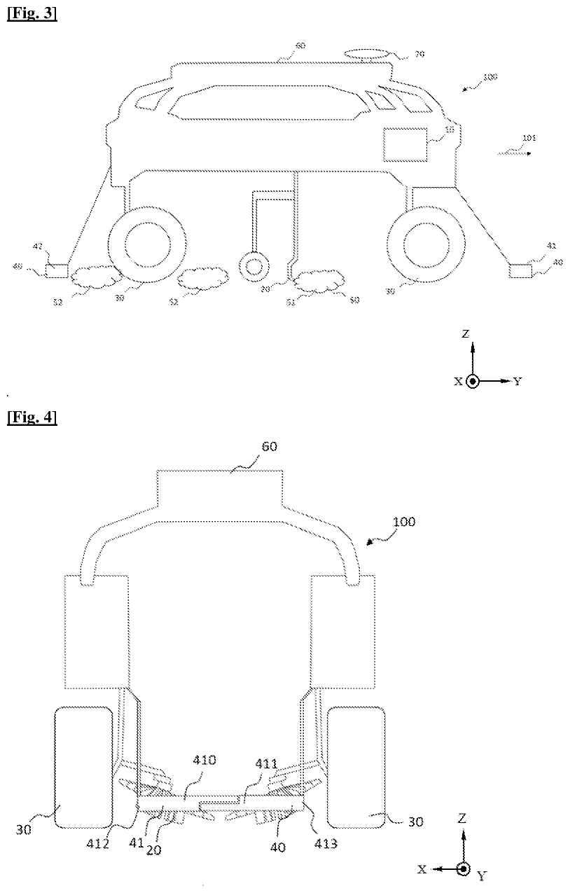

FIG. 1, FIG. 2 and FIG. 3 illustrate a side view of an autonomous agricultural robot 100. Said autonomous agricultural robot comprises a control unit 10, treatment tools 20 allowing treating crops 50.

The control unit 10 conventionally comprises a calculator.

The autonomous agricultural robot 100 can evolve in a crop parcel 50. A crop parcel 50 may comprise several crops of the same type or of different types.

The treatment tools 20 may include, in a non-limiting manner, Kress fingers, mulcher disks, mechanical intercepts, serrated disks, or knives.

The treatment tools 20 may also be movable between two positions, a so-called work position and a raised position. In the work position, the treatment tools 20 treat the crops 50. In the raised position, the treatment tools 20 have no contact with the crops 50. All or part of the treatment tools 20, in the raised position, may be inclined substantially parallel to the ground on which the autonomous agricultural robot 100 evolves. All or part of said treatment tools 20 may also be offset transversely with respect to the advance direction 101.

The autonomous agricultural robot 100 may also comprise an automatic device for positioning the treatment tools 20. Said device is conventionally connected to the control unit 10. Said control unit is then configured to transmit thereto commands for positioning the treatment tools 20, said treatment tools then being positioned in the transmitted position.

In a non-limiting manner, the crops 50 are crops arranged in rows in the described aspect. The crops 50 may have a large size, like vine stocks, a medium size like wheat, or a small size like salads.

The autonomous agricultural robot 100 comprises forward movement means 30. Said forward movement means enable the autonomous agricultural robot 100 to advance in a so-called advance direction 101.

The control unit 10 is conventionally connected to the treatment tools 20 and to the forward movement means 30. It may be configured to send a command for setting the treatment tools 20 into a raised position. In this case, the treatment tools 20 are positioned in the raised position. Similarly, the control unit 10 may be configured to send a command for stopping the forward movement means 30. In this case, the forward movement means brake until stopping the autonomous agricultural robot 100.

The autonomous agricultural robot 100 could advance at a speed so-called the treatment speed during the treatment of the crop parcel.

The autonomous agricultural robot 100 also comprises a device 40 for protecting the crop parcel. The protection of the crop parcel means that if a crop 50 (or a limited number of crops 50) has been damaged by the treatment tools 20, the other crops of the crop parcel 50 are protected from the treatment tools 20.

Henceforth, an upstream crop 51 at a time point t1 may become a downstream crop 52 at a time point t2, if t1 is less than t2, and if between t1 and t2, the treatment tools 20 have treated said culture.

The protective device measures characteristic quantities of the crops 50 which will be explained in the rest of the description.

The control unit 10 is configured to receive the measurements of the characteristic quantities originating from the protective device 40 of the crops 50. It is also configured to process the measurements of the characteristic quantities read by the device 40 for protecting the same crop 50 before and after the passage of the treatment tools 20.

The control unit 10 is then configured to associate the measurements of the characteristic quantities of the same crop 50 originating from the protective device 40.

The agricultural robot may also comprise a location system 70. For example, the location system 70 comprises a satellite positioning system, such as the GPS (English acronym standing for Global Position System) system.

The control unit is then configured to associate with each measurement a characteristic quantity of a crop 50, a positioning of said culture determined by the location system 70. Characteristic quantities associated with the same positioning are considered as being associated with the same crop 50.

The control unit 10 is configured to perform a comparison of the measurements of the characteristic quantities read by the protective device 40 of the same crop 50 before and after passage of the treatment tools 20.

When the comparison exceeds a predefined threshold, the control unit 10 may be configured to send a command for stopping the autonomous agricultural robot 100.

This stop command may be in several forms. The control unit 10 may be configured to send a stop command to the forward movement means 30.

The control unit 10 may be configured to transmit a command for setting the treatment tools 20 into a raised position.

The control unit 10 may also be configured to send an error message intended for an operator to an external medium.

These stop commands may be cumulated.

The measured characteristic quantities are intended to be representative of the state of the crops 50. For example, a crop 50 in good state which has then been degraded by the treatment tools 20 features a difference between the measurement of its characteristic quantity measured at t1 by the first protective device 40 on the upstream crop 51 and the measurement of its characteristic quantity measured at t2 by the protective device 40 on the same downstream crop 52.

The device 40 for protecting the crop parcel 50 may comprise a first device 41 for characterising the so-called upstream crops 51. The upstream crops 51 are located upstream of the treatment tools 20, before passage of the treatment tools 20 over the upstream crops 51 with respect to the advance direction 101. In other words, these upstream crops 51 have not been treated by the treatment tools 20 at a time point t1, as shown in FIG. 1.

The device 40 for protecting the crop parcel 50 may also comprise a second device 42 for characterising the so-called downstream crops 52. The downstream crops 52 are located downstream of the treatment tools 20, after passage of the treatment tools 20 on the downstream crops 52 with respect to the advance direction 101. In other words, these downstream crops 52 have been treated by the treatment tools 20 at a time point t2, as shown in FIG. 2.

In a first aspect shown in FIG. 1 and FIG. 2, the two characterisation devices 41, 42 may comprise image sensors. These image sensors may be CMOS sensors. These sensors may be directed towards the soil. They may also be directed in a plane normal to the advance direction 101.

The measured characteristic quantities may be an image of the crop. Thus, if a difference in pixels is observed between the two images of the same crop 50 before and after the treatment by the treatment tools 20, this could mean that the crop 50 has been degraded.

The characteristic quantities may also consist of the width of the crop 50, the width being defined as a dimension of the crop in a plane parallel to the soil on which the autonomous agricultural robot 100 evolves and perpendicular to its advance direction 101. In particular, this characteristic quantity could reflect cutting or uprooting of the crop 50.

The control unit 10 may be configured to extract the width of a crop from an image extracted from a CMOS sensor following an image processing.

The characteristic quantities may also consist of the height of the crop 50. The height is defined as the dimension of the crop 50 according to an axis substantially perpendicular to the soil on which the autonomous agricultural robot 100 evolves. In particular, this characteristic quantity could reflect cutting or uprooting of the crop 50.

The control unit 10 may be configured to extract the height of a crop 50 from an image extracted from a CMOS sensor following an image processing.

The characteristics quantities may also consist of the angle formed by the crop 50 with respect to the soil on which the autonomous agricultural robot 100 evolves. In particular, this characteristic quantity could reflect crushing of the crop 50, especially if the latter is a tall crop.

The characteristic quantities may also be the position of the crop 50. Thus, this characteristic quantity could in particular reflect unrooting and displacement of the crop 50.

Similarly, the characteristic quantities may also be a spacing between the crop 50 and another crop of the parcel. Similarly, this characteristic quantity could in particular reflect unrooting and displacement of the crop 50.

Preferably, the spacing is measured between two neighbouring crops 50, i.e. one is treated just after the other by the treatment tools 20.

The control unit 10 may be configured to extract the angle formed by a crop 50 with the soil on which the autonomous agricultural robot 100 evolves from an image extracted from a CMOS sensor following an image processing.

Preferably, the two characterisation devices 41, 42 measure the same characteristic quantity.

The two characterisation devices 41, 42 may comprise the same sensors. The sensors may be connected to the control unit 10.

The two characterisation devices 41, 42 may be positioned on the autonomous agricultural robot 100 respectively upstream and downstream of the treatment tools 20 according to the advance direction 101. Preferably, they are fastened on the autonomous agricultural robot 100.

FIG. 3 shows a second aspect of the autonomous agricultural robot 100. The autonomous agricultural robot 100 comprising a straddle frame 60, defining a passage corridor for a crop row. This figure shows the two characterisation devices 41, 42, which may comprise movable arms. The movable arms are arranged respectively on either side of a longitudinal midplane of the passage corridor. The two characterisation devices 41, 42 also comprise one sensor per arm configured to measure a change in the position of said arm.

FIG. 4 shows another aspect of the agricultural robot 100, comprising the same characterisation devices 41, 42. In this aspect, yet in a non-limiting manner, the arms 410, 411 of the characterisation device 41 are movable in rotation and their sensors 412, 413 consist of angular sensors.

These characterisation devices 41, 42 may be configured to measure the width of the crop 50 as a characteristic quantity. This width is geometrically related to the angles measured by the angular sensors 412, 413. Thus, the measurements of angles originating from the angular sensors 412, 413 characterise the width of the crop 50.

The movable arms may be movable in translation in a plane perpendicular to the longitudinal midplane of the passage corridor. They could then be associated with linear displacement sensors.

Similarly, these characterisation devices may be configured to measure the width of the crop 50 as a characteristic quantity. This width is geometrically related to the movements measured by the linear displacement sensors. Thus, the measurements of angles originating from the angular sensors 412, 413 characterise the width of the crop 50.

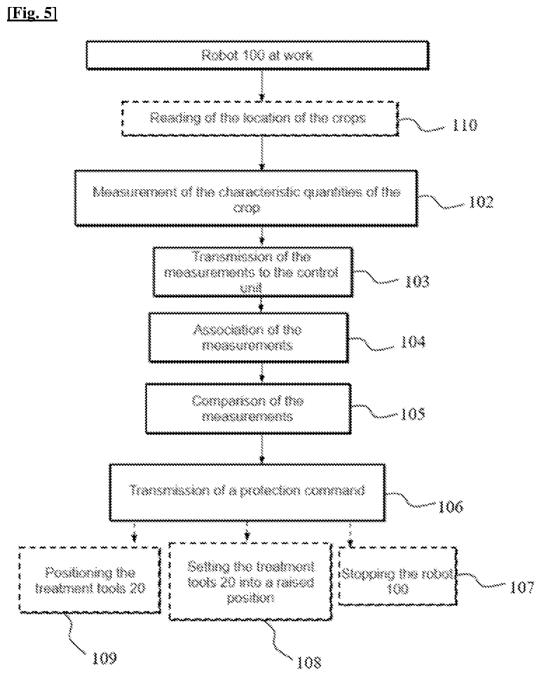

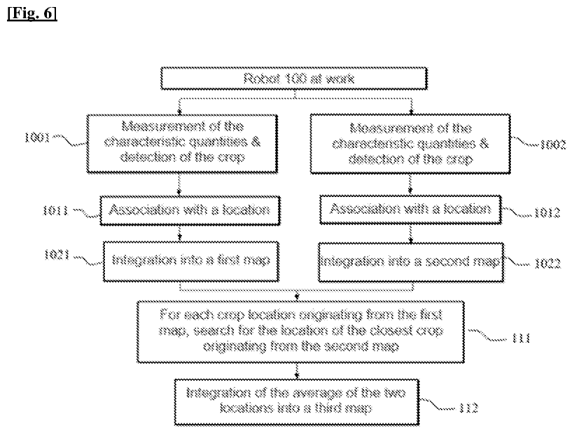

The disclosure also relates to a method for protecting a crop parcel 50, illustrated in FIG. 5. This method may be implemented by a previously-described autonomous agricultural robot 100, in any one of its aspects, when the autonomous agricultural robot 100 is at work. This method comprises a first step 102 of measuring the characteristic quantities of the upstream 51 and downstream 52 crops by the protective device. These characteristic quantities may be representative of the state of the upstream and downstream crops 51, 52.

Afterwards, the protective device transmits the measurements to the control unit 10 during step 103. Preferably, the transmission of the measurements is carried out in a wired manner. It may also be carried out by other transmission means.

A next step 104 consists in associating the measurements of the characteristic quantities of the same crop originating from the protective device 40 before passage of the tools (upstream crop 51) and after passage of the tools (downstream crop 52). When the autonomous agricultural robot 100 advances, a culture at a time point t1 located in front of the tools according to the advance direction 101 is an upstream crop 51. Afterwards, the crop 50 is treated by the treatment tools 20, before becoming a downstream crop 52, at a time point t2.

Each of the characteristic quantities may be associated with a time measurement during step 104. For example, this time measurement may correspond to the hour, the minute and the second of capture of the measurement. The difference between the two time measurements originating from different characterisation devices may be associated with a distance by multiplying it by the speed of the autonomous agricultural robot 100.

The association of the measurements 104 of the characteristic quantities of the same upstream 51 and downstream 52 crop may comprise a first association. The latter primarily associates each of said measurements with a time measurement.

For the same crop 50, the difference between the two time measurements multiplied by the speed of the autonomous agricultural robot 100 may be associated with the distance d separating the locations where the measurements of the characteristic quantities of the upstream 51 and downstream 52 crops are carried out.

Afterwards, the measurements of the characteristic quantities of the upstream 51 and downstream 52 crops originating from the protective device 40, including the difference of the time measurements corresponding to the distance d divided by the speed of the autonomous agricultural robot 100, are associated during a second association, in the step of associating the measurements 104.

When the method is implemented by an autonomous agricultural robot 100 comprising the satellite positioning system 70, such as the GPS (English acronym standing for Global Position System) system, the method may comprise a complementary preliminary step. Step 110 comprises reading the location of the crops 50 using the satellite positioning system.

Step 104 may then comprise a first association of each measurement of characteristic quantities of a crop 50 by the protective device 40 with a positioning estimated by the system for locating the characterised crop 50.

Step 104 may also comprise a second association of a measurement of characteristic quantities of an upstream crop 51 originating from the protective device 40 and of a measurement of characteristic quantities of a downstream crop 52 originating from the protective device 40, the two measurements being associated with the same positioning of the characterised crop. A tolerance threshold may be applied to the measurement of the positioning.

The method comprises a step 105. Step 105 comprises comparing two measurements of characteristic quantities of the same upstream 51 and downstream 52 crop originating from the protective device 40.

If the comparison is below a predetermined threshold, i.e. the characteristic quantities of the upstream crop 51 at the time point t1 and of the downstream crop 52 at the time point t2 are identical within a tolerance margin, this means that the crop has the same characteristic quantity before and after passage of the treatment tools 20.

In other words, the treatment tools 20 have not damaged the crop 50 and the protective device 40 is not defective.

If the comparison is above the predetermined threshold, i.e. the characteristic quantities of the upstream culture 51 at the time point t1 and of the downstream crop 52 at the time point t2 are different, this means that the crop does not have the same characteristic quantity before and after passage of the treatment tools 20.

In other words, the treatment tools 20 have damaged the crop 50 or the protective device 40 is defective.

The predefined threshold may be set by an operator, via an external medium (not shown) connected to the control unit 10, for example. Said threshold may depend on the tolerance of the comparison of the compared characteristic quantities accepted by the operator and the accuracy of the protective device 40.

The method comprises a step 106. The step 106 comprises transmitting a command for protecting the crop parcel by the control unit 10 to the autonomous agricultural robot 100 if the comparison exceeds the predefined threshold.

The protection command may be transmitted by the control unit 10 to the forward movement means 30 during a step 107. The forward movement means 30 then stop the autonomous agricultural robot 100. Thus, the crop parcel 50 is protected.

The protection command may be transmitted by the control unit 10 to the treatment tools 20 during a step 108. It may consist of a command for setting in the raised position. The treatment tools 20 no longer contact the rest of the crop parcel 50. Thus, the crop parcel 50 is protected.

The protection command may be transmitted by the control unit 10 to an external operator via the external medium (not shown). Afterwards, the operator could steer the autonomous agricultural robot to safeguard the crop parcel 50.

The protection command may comprise, for an autonomous agricultural robot 100 comprising an automatic device for positioning the treatment tools 20 during a step 109, an analysis of the comparison and a transmission to the treatment tools 20 of a command for positioning of the treatment tools. Thus, if the characteristic quantity, for example, in a non-limiting manner, is an image, an analysis may be carried out on the distribution of the pixels between the image of the upstream crop 51 and the image of the downstream crop 52. For example, this comparison could reveal that the downstream crop 52 has been damaged (cut for example) at one of its ends. This could mean that the treatment tools 20 have been maladjusted and therefore poorly positioned.

The analysis of the comparison could allow determining the distance from which the treatment tools 20 should be repositioned so that said tools do not damage the crop parcel 50. The control unit extracts said distance and transmits it to the automatic positioning device of the treatment tools 20.

When the comparison is higher than the predefined threshold, the control unit 10 could also generate a command for slowing the forward movement means 30.

If, after step 109, the comparison falls below the predefined threshold for a predefined time period, the control unit 10 could generate a command for returning to the treatment speed to the forward movement means 30. This means that the treatment tools 20 have been adjusted and no longer present any danger to the crop parcel 50. The predefined time period may be integrated into the control unit 10 by the operator.

If, after step 109, the comparison does not fall below the predefined threshold for a predefined time period, the control unit 10 could generate a command for stopping the autonomous agricultural robot 100. This means that the treatment tools 20 have not been properly adjusted and that the crop parcel 50 is not safe. The predefined time period may be integrated into the control unit by the operator.

Similarly, if, after step 109, the comparison does not fall below the predefined threshold for a predefined time period, the control unit 10 could generate a command for setting the treatment tools 20 into a raised position. This means that the treatment tools 20 have not been automatically adjusted in a proper manner and that the crop parcel is not safe. The predefined time period may be integrated into the control unit by the operator.

The method may comprise an additional step 109 of maintaining the treatment tools 20. The treatment tools 20 may be adjusted by an operator.

The method may also comprise an additional step of maintaining the device 40 for protecting a crop parcel 50.

The disclosure also relates to a method for mapping a crop parcel 50 implemented by a previously-described autonomous agricultural robot, comprising a location system, illustrated in FIG. 6. Said method comprises a first step 1001 of measuring the characteristic quantities of the crops 50 by the first device 41 for characterising the crops 50. These measurements are transmitted to the control unit 10, which detects the crops 50. For example, when the measured characteristic quantity is the width of the culture, the detection of the culture 10 is carried out at the location where the measured width is the largest.

The method comprises a second step 1011 of associating, by the control unit 10, each of the detected crops 50 with their locations read by the location system 70.

The method comprises a third step 1021 of integrating the location of each of the crops 50 with a first map. The map may group together the positioning information of the crops, an indexing of the crops, as well as the measurements of the associated characteristic quantities.

In parallel with these three preceding steps, the following three steps are carried out:
a step 1002 of measuring the characteristic quantities of the crops 50 by the second device 42 for characterising the crops 50 and detecting the crops 50;
a step 1012 of associating, by the control unit 10, each of the detected crops 50 with their locations read by the location system 70;
a step 1022 of integrating the location of each of the crops 50 with a second map.

In a step 111, for each crop location originating from the first map, the processing unit 10 searches for the location of the closest crop 50 originating from the second map and associates the two locations together.

In a step 112, for each crop from the first map, the control unit 10 calculates the average of the two locations originating from the first and second maps and integrates it into a third map. Afterwards, the third map could be used as input information for the preparation of a processing circuit of an autonomous agricultural robot 100.

What is claimed is:

1. An autonomous agricultural robot comprising: a control unit; treatment tools allowing treating crops; forward movement means enabling the autonomous agricultural robot to advance in a so-called advance direction within a crop parcel; said autonomous agricultural robot being characterised in that it comprises a device for protecting the crop parcel, this protective device being configured to: measure characteristic quantities of the so-called upstream crops, these crops being located upstream of the treatment tools before passage of the treatment tools over the crops with respect to the advance direction; measure characteristic quantities of said downstream crops, said crops being located downstream of the treatment tools after the treatment tools pass over the crops with respect to the advance direction; the control unit being configured to: receive the measurements of the characteristic quantities of the upstream and downstream crops originating from the protective device; process the measurements of the characteristic quantities of the crops read by the protective device and performing a comparison of the measurements of the characteristic quantities of the same upstream and downstream crop, corresponding to the comparison of the characteristic quantities of said culture before and after passage of the treatment tools; transmit a command for protecting the crop parcel to the autonomous agricultural robot when the comparison exceeds a predefined threshold.

2. The autonomous agricultural robot according to claim 1, wherein the characteristic quantities measured by the device for protecting the crops are an image of the crop and/or the width of the crop and/or the height of the crop and/or the angle formed by the crop with the soil and/or the position of the crop, and/or a spacing between the crop and another crop of the parcel.

3. The autonomous agricultural robot according to claim 1, wherein the treatment tools are movable between two positions, a work position and a raised position, the control unit being configured to transmit the crop parcel protection command to the treatment tools which are positioned in the raised position.

4. The autonomous agricultural robot according to claim 1, wherein the control unit is configured to transmit the crop parcel protection command to the forward movement means to stop the autonomous agricultural robot.

5. The autonomous agricultural robot according to claim 1, wherein the protective device comprises an image sensor.

6. The autonomous agricultural robot according to claim 1, comprising a straddle frame defining a passage corridor for a crop row, wherein the protective device comprises movable arms arranged respectively on either side of a longitudinal midplane of the passage corridor, and one sensor per arm configured to measure a change in the position of said arm.

7. The autonomous agricultural robot according to claim 1, comprising a location system, wherein the control unit is configured to associate the measurements of the characteristic quantities, read by the protective device, of the upstream and downstream crops at a position, estimated by the positioning system, of the characterised crop.

8. The autonomous agricultural robot according to claim 1, wherein the device for protecting the crop parcel comprises two characterisation devices, the first characterisation device being configured to measure the characteristic quantities of the upstream crops; the second characterisation device being configured to measure the characteristic quantities of the downstream crops.

9. The autonomous agricultural robot according to claim 1, wherein the two crop 50 characterisation devices comprise sensors of the same type.

10. The autonomous agricultural robot according to claim 9, wherein:
the device for protecting the crop parcel comprises two characterisation devices, the first characterisation device being configured to measure the characteristic quantities of the upstream crops; the second characterisation device being configured to measure the characteristic quantities of the downstream crops; and
the first crop characterisation device is positioned upstream of the treatment tools and the second crop characterisation device is positioned downstream of the treatment tools.

11. A method for protecting a crop parcel-implemented by an autonomous agricultural robot based on claim 1, including the steps of: measuring the characteristic quantities of the upstream and downstream crops by the protective device; transmitting said measurements to the control unit; associating, by the control unit, measurements of the same upstream and downstream culture originating from the protective device; comparing, by the control unit, the associated measurements; transmitting a command for protecting the crop parcel by the control unit to the autonomous agricultural robot if the comparison exceeds a predefined threshold.

12. The method for protecting a crop parcel according to claim 11, implemented by an autonomous agricultural robot comprising a location system, wherein the control unit is configured to associate the measurements of the characteristic quantities, read by the protective device, of the upstream and downstream crops at a position, estimated by the positioning system, of the characterised crop; and
the method for protecting the crop parcel including an additional preliminary step of reading the location of the crops by the location system, the step of associating the measurements by the control unit comprising a first association of each measurement of characteristic quantities of a crop originating from the protective device with a positioning estimated by the location system of the characterised crop and a second association of the measurements of characteristic quantities originating from the protective device associated with the same positioning, said measurements corresponding to the measurements of the characteristic quantities of the same upstream and downstream crop.

13. The method for protecting a crop parcel according to claim 11, implemented by an autonomous agricultural robot comprising an automatic device for positioning the treatment tools wherein the step of transmitting a command for protecting the crop parcel by the control unit to the autonomous agricultural robot if the comparison exceeds a predefined threshold comprises analysing the comparison and transmitting to the treatment tools a command for positioning the treatment tools.

14. The method for protecting a crop parcel according to claim 11, wherein the step of transmitting a command for protecting the crop parcel by the control unit to the autonomous agricultural robot if the comparison exceeds a predefined threshold comprises transmitting a stop command by the control unit to the forward movement means of the autonomous agricultural robot.

15. The method for protecting a crop parcel according to claim 11, wherein the step of transmitting a command for protecting the crop parcel by the control unit to the robot autonomous agricultural if the comparison exceeds a predefined threshold comprises transmitting a command for protecting the crop parcel by the control unit to the treatment tools which are in a so-called raised position, corresponding to a position in which said treatment tools have no contact with the crops.

16. A method for mapping a crop parcel implemented by an autonomous agricultural robot based on claim 7, including the steps of: measuring the characteristic quantities of the upstream crops by the protective device, transmitting to the control unit and detecting the upstream crops by the control unit; associating, by the control unit, each of the detected upstream crops with their locations read by the location system; integrating the location of each of the upstream crops with a first map by the control unit; implemented in parallel with the following three steps: measuring the characteristic quantities of the downstream crops by the protective device, transmitting to the control unit and detecting the downstream crops by the control unit; associating, by the control unit, each of the detected downstream crops with their locations read by the location system; integrating the location of each of the downstream crops with a second map by the control unit; for each location of the upstream crops originating from the first map, searching for the location of the closest downstream crop originating from the second map and associating the two locations by the control unit; for each upstream crop derived from the first map, integrating the average of the two locations originating from the first and second maps into a third map by the control unit.
